(19) United States
(12) Patent Application Publication
(10) Pub. No.: US 2024/0077202 A9
(43) Pub. Date: Mar. 7, 2024

(54) WIND-ASSISTED AIR SUPPLY TO COAL-FIRED POWER PLANTS

(71) Applicant: Sammy Kayara, Naples, FL (US)

(72) Inventor: Sammy Kayara, Naples, FL (US)

(21) Appl. No.: 16/889,523

(22) Filed: Jun. 1, 2020

Related U.S. Application Data
(63) Continuation-in-part of application No. 16/386,451, filed on Apr. 17, 2019, now Pat. No. 10,669,935.
(60) Provisional application No. 62/658,860, filed on Apr. 17, 2018.

(51) Int. Cl. F23L 5/04; F01K 7/16; F01K 23/06

(52) U.S. Cl. CPC F23L 5/04; F01K 7/16; F01K 23/067; F05D 2220/31; F05D 2260/60

(57) ABSTRACT

A system for providing wind-assisted air supply to coal-fired power plants through the use of a wind funnel communicating with an air handler system of a coal-fired boiler is disclosed. The shape, size and orientation of the wind funnel may be controlled in order to optimize the collection of wind and generation of increased air pressure for delivery to the coal-fired boiler system. Increased operating efficiency of coal-fired power plants may be achieved with the wind funnel system.

### CROSS-REFERENCE TO RELATED APPLICATION

This application is a continuation-in-part of U.S. patent application Ser. No. 16/386,451 filed Apr. 17, 2019, now U.S. Pat. No. 10,669,935, which is incorporated herein by reference.

### FIELD OF THE INVENTION

The present invention relates to coal-fired power plants, and more particularly relates to wind-assisted air supply to coal-fired power plant boiler systems.

### BACKGROUND INFORMATION

Conventional coal-fired power plant boilers use coal as a fuel source that is combusted in the presence of ambient air. It would be desirable to increase the efficiency of such coal-fired power plants.

### SUMMARY OF THE INVENTION

The present invention provides wind-assisted air supply to coal-fired power plants through the use of a wind funnel communicating with an air handler system of a coal-fired boiler. The shape, size and orientation of the wind funnel may be controlled in order to optimize the collection of wind and generation of increased air pressure for delivery to the coal-fired boiler system. Increased operating efficiency of coal-fired power plants may be achieved with the wind tunnel system.

An aspect of the present invention is to provide a wind funnel and coal-fired power plant system comprising: a wind funnel comprising an inlet opening having a cross-sectional area and an outlet opening having a cross-sectional area less than the cross-sectional area of the inlet opening, wherein the wind funnel is inwardly tapered between the inlet opening and the outlet opening; an air handler system in air flow communication with the wind funnel; and a coal-fired electrical power generation system in air flow communication with the air handler system structured and arranged to receive at least a portion of compressed air delivered from the wind funnel through the air handler system.

Another aspect of the present invention is to provide a method of operating a wind funnel and coal-fired power plant system comprising: feeding compressed air from a wind funnel to an air handler system; and delivering at least a portion of the compressed air from the wind funnel through the air handler system to a coal-fired electrical power generation system.

These and other aspects of the present invention will be more apparent from the following description.

### BRIEF DESCRIPTION OF THE DRAWINGS

FIG. 1 is a schematic diagram illustrating features of a wind-funneling system for coal-fired power plants in accordance with an embodiment of the present invention.

FIG. 2 is a schematic flow diagram of a wind-funneling system incorporated in a coal-fired power plant in accordance with an embodiment of the present invention.

FIG. 3 is a schematic flow diagram of a wind-funneling system incorporated in a coal-fired power plant in accordance with an embodiment of the present invention.

FIG. 4 is a schematic flow diagram of a wind-funneling system incorporated in a coal-fired power plant in accordance with an embodiment of the present invention.

FIG. 5 is a partially schematic side view of a wind funnel for delivering pressurized air to a coal-fired boiler in accordance with an embodiment of the present invention.

FIG. 6 is a partially schematic top view of a wind funnel for delivering pressurized air to a coal-fired boiler in accordance with an embodiment of the present invention.

FIG. 7 is a partially schematic top view of a wind funnel for delivering pressurized air to a coal-fired boiler illustrating rotation of a wind funnel into multiple orientations in accordance with an embodiment of the present invention.

FIG. 8 is a partially schematic side view of a wind funnel in accordance with another embodiment of the present invention.

FIG. 9 is a partially schematic side view of a wind funnel in accordance with a further embodiment of the present invention.

FIG. 10 is a partially schematic end view of the inlet opening of a wind funnel in accordance with an embodiment of the present invention.

FIG. 11 is a partially schematic end view of the inlet opening of a wind funnel in accordance with another embodiment of the present invention.

FIG. 12 is a partially schematic end view of the inlet opening of a wind funnel in accordance with a further embodiment of the present invention.

FIG. 13 is a partially schematic end view of the inlet opening of a wind funnel in accordance with another embodiment of the present invention.

FIG. 14 is a partially schematic end view of the inlet opening of a wind funnel in accordance with a further embodiment of the present invention.

FIG. 15 is a partially schematic top view of a wind funnel illustrating inlet and outlet air velocities in accordance with an embodiment of the present invention.

FIG. 16 is a partially schematic top view of a wind funnel in accordance with an embodiment of the present invention.

FIG. 17 is a partially schematic top view of a wind funnel in accordance with another embodiment of the present invention.

FIG. 18 is a partially schematic top view of a wind funnel in accordance with a further embodiment of the present invention.

### DETAILED DESCRIPTION

As used herein, the terms “coal-fired boiler”, “coal-fired power plant” and “coal-fired electrical power generation system” mean boilers, power plants and electrical power generation systems that use coal as a fuel source that is combusted to generate heat that is used to create steam that may be delivered to a steam turbine for powering an electrical generator.

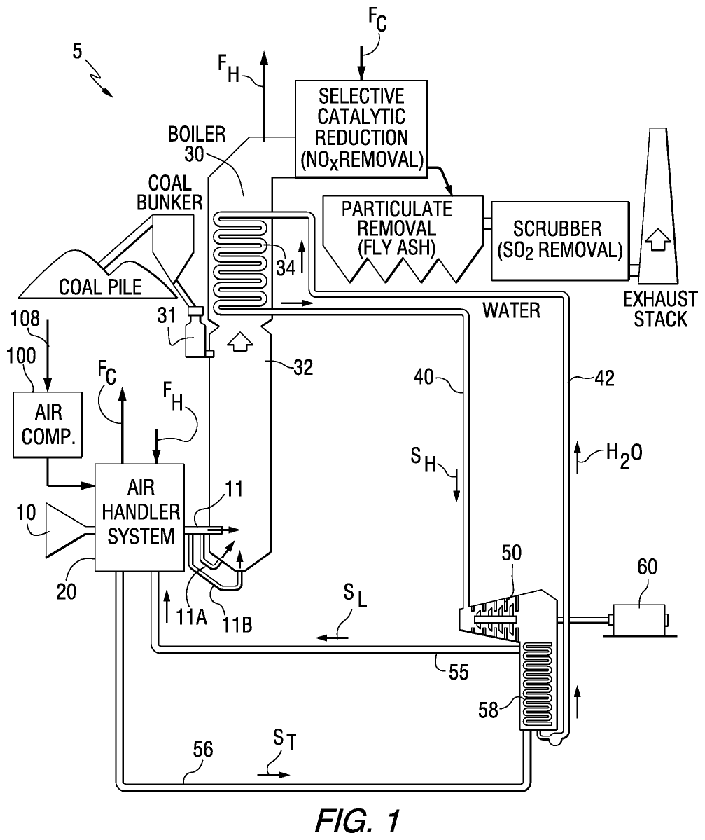

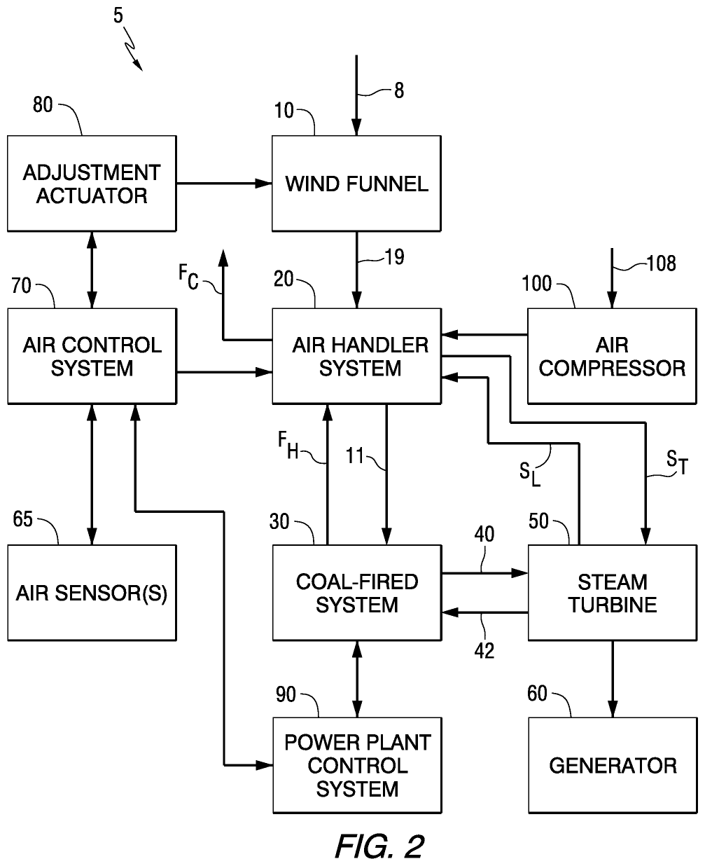

FIGS. 1 and 2 schematically illustrate a wind funnel and coal-fired power plant system 5 in accordance with an embodiment of the present invention. A wind funnel 10, as more fully described below, communicates with a coal-fired boiler 30 of a power plant via an air handler system 20. Pressurized air from the wind funnel 10 is delivered to the coal-fired boiler 30. Steam generated by the coal-fired boiler 30 is transferred by a steam delivery line 40 to a conventional turbine 50 and electrical power generator 60. As more fully described below, air sensor(s) 65, an air control system 70, wind funnel adjustment actuator 80, and a power plant control system 90 may be provided.

The coal-fired boiler 30 includes a coal inlet 31 that feeds coal and optional additives into the lower portion of the boiler 30. A combustion zone 32 is provided in the coal-fired boiler 30, which may be any known type of conventional coal-fired boiler, fluidized bed combustor, circulating fluidized bed combustor, pressurized fluidized bed combustor or the like known to those skilled in the art. A heat exchanger 34 comprising heat transfer pipes is provided at or above the combustion zone 32.

As shown in FIG. 1, the wind funnel 10 is used to feed compressed air through an air inlet 11 into the combustion zone 32 of the coal-fired boiler 30 In the embodiment shown, two additional air inlets 11A and 11B are used to introduce the compressed air at different locations in the coal-fired boiler 30. For example, when the coal-fired boiler includes a conventional fluidized bed known to those skilled in the art, the air inlet 11 may feed air into the combustion zone 32 above the fluidized bed, the second air inlet 11A may feed air into the fluidized bed, and the third air inlet 11B may feed air below the fluidized bed.

As further shown in FIG. 1, heat generated in the combustion zone 32 is used to heat water contained inside heat transfer pipes of the heat exchanger 34 into high pressure steam S_{H} that is fed via the steam delivery line 40 to the steam turbine 50. Rotation of the steam turbine is used to generate high-voltage electricity in the generator 60. Water H₂O is returned to the heat exchanger 34 by water return line 42 after passing through a condenser 58, which is schematically shown in FIG. 1. The steam delivery line 40 is thus used to transfer high pressure steam S_{H} from the coal-fired boiler 30 to the steam turbine 50, and water H₂O from the condenser 58 of the steam turbine 50 is then returned via line 42 to the heat exchanger 34 contained within the coal-fired boiler 30. FIG. 1 also illustrates the removal of particulate fly ash from the coal-fired boiler 30, as well as removal of NOₓ and SO₂ prior to release of exhaust gas through an exhaust stack.

As shown in FIGS. 1 and 2, the air handler system 20 may receive hot flue gas F_{H} from the coal-fired boiler 30, and may discharge relatively cold flue gas F_{C} e.g., after the hot flue gas F_{H} passes through a pre-heater, heat exchanger or the like contained in the air handler system 20. In the embodiment shown in FIG. 1, the cold flue gas F_{C} is delivered to a catalytic reduction section of the coal-fired power plant 5. The air handler system 20 may also receive low pressure steam S_{L} from the turbine 50 through a low pressure steam line 55. Lower temperature steam S_{T} or water may be recirculated by a low temperature steam line 56 from the air handler system 20 to the condenser 58 for the steam turbine 50.

A benefit of providing compressed fresh air from the wind funnel 10 allows for more efficient transfer of heat from either steam or from flue gas to the compressed fresh air before being sent to the coal-fired boiler 30. Coal consumption costs may therefore be lowered. Higher pressures of the compressed air from the wind funnel 10 provide greater thermal transfer than non-compressed or lower pressure air. Another benefit of providing compressed air from the wind funnel 10 is that energy required by conventional fans to deliver air is reduced or avoided.

As shown in FIG. 2, an air compressor 100 may intake ambient air 108 and deliver slightly pressurized air to the air handler system 20. Ambient air 108 that has not passed through the wind funnel 10 may thus be selectively delivered to the coal-fired system 30 via the air handler system 20.

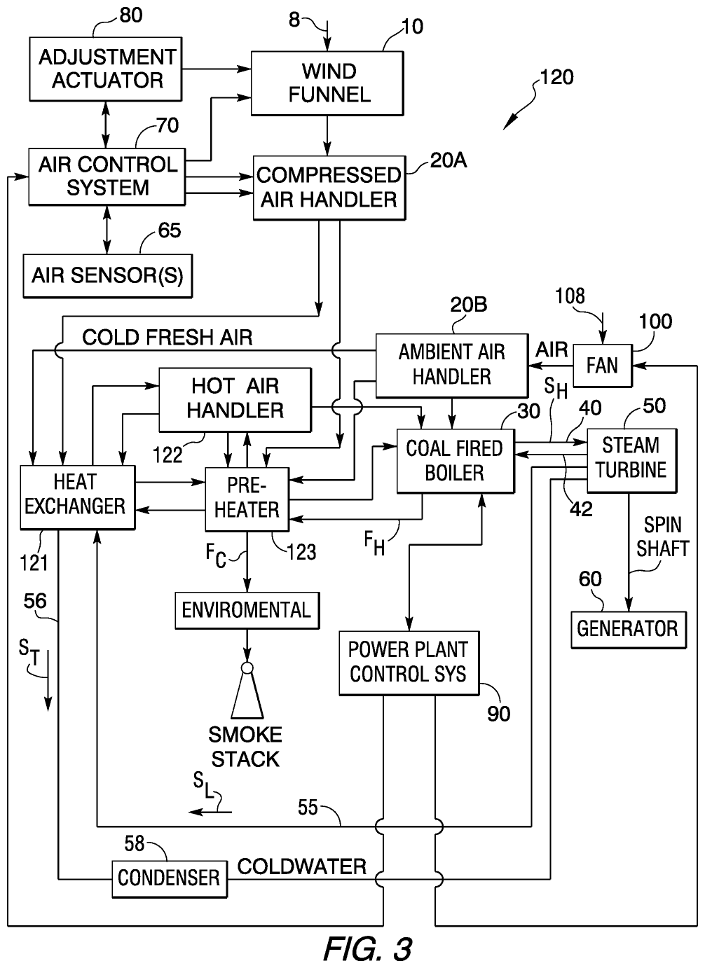

In the embodiment shown in FIG. 3, the air handler system of a wind funnel and coal-fired power plant system 120 includes a compressed air handler 20A and an ambient air handler 20B. Compressed air from the wind funnel 10 is delivered to the compressed air handler 20A followed by delivery to a heat exchanger 121 and/or a pre-heater 123. Air from the heat exchanger 121 may be delivered to the pre-heater 123, or may be delivered to a hot air handler control system 122. Air may be exchanged between the hot air handler control system 122 and the pre-heater 123. Furthermore, air may be delivered to the coal-fired boiler 30 by the hot air handler control system 122 and/or the pre-heater 123. In the embodiment shown, hot flue gas F_{H} is delivered from the coal-fired boiler 30 to the pre-heater 123. Relatively cold exhaust air may be transferred from the pre-heater 123 for release through an exhaust or smoke stack, e.g., after passing through an environmental stage such as the selective catalytic reduction illustrated in FIG. 1.

As further shown in FIG. 3, ambient air 108 may be drawn into an air compressor 100 having a fan to provide slightly pressurized air that is fed to the ambient air handler 20B. Air may be delivered from the ambient air handler 20B to the coal-fired boiler 30. In addition, at least a portion of the ambient air from the ambient air handler 20B may be delivered to the heat exchanger 121 and/or pre-heater 123. Although not shown in FIG. 3, at least a portion of the compressed air from the wind funnel 10 that passes through the compressed air handler 20A may be delivered to the coal-fired boiler 30, e.g., as shown in FIGS. 1 and 2.

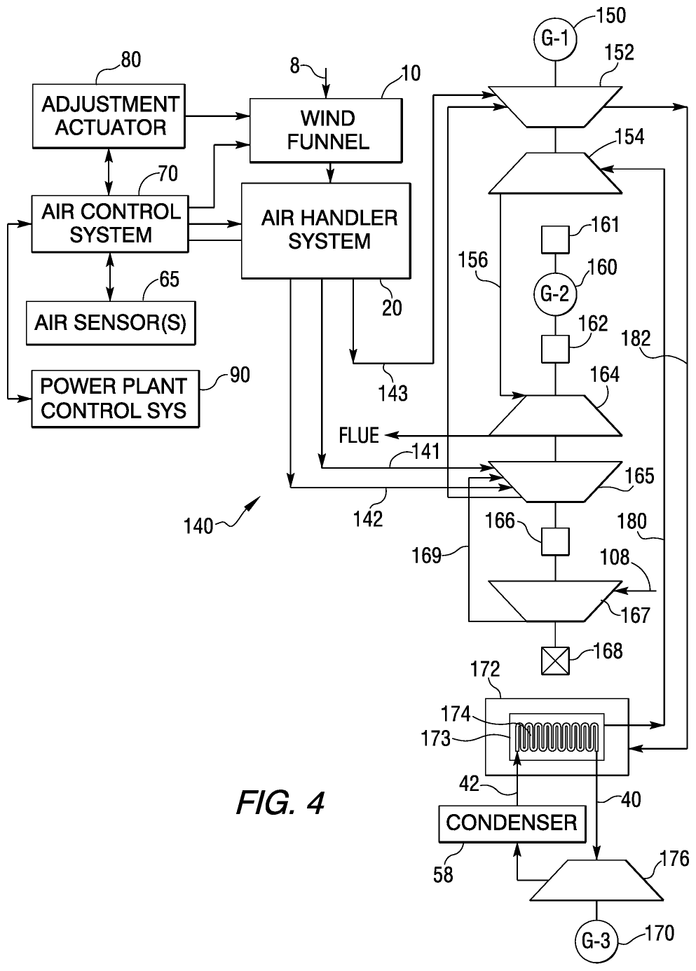

In the embodiment shown in FIG. 4, a wind funnel and coal-fired power plant system 140 includes a first gas combustion generator section 150, a second gas combustion generator section 160, and a steam generator section 170. The first gas combustion generator section 150 includes a high-pressure compressor 152 and a first gas turbine 154. The second gas combustion generator section 160 includes an actuator 156, a first coupler 162, a second gas turbine 164, a mid-pressure compressor 165, a second coupler 166, a low pressure compressor 167 and an actuator 168. Ambient air 108 may be delivered to the low-pressure compressor 167.

The steam generator section 170 includes a conventional pressurized fluidized bed combustor pressure vessel 172, boiler 173. and heat exchanger 174 known to those skilled in the art. The boiler 173 surrounds the heat exchanger 174 High pressure steam from the heat exchanger 174 is fed by the steam delivery line 40 to a steam turbine 176. After the steam turbine 176 spins and work in its spinning shaft is extracted, water is then fed back to the pressurized heat exchanger 174 via water return line 42 after passing through the condenser 58. Combustible syngas is fed from the boiler 173 to the first stage gas turbine 154 via line 180, High pressure air is fed from the high pressure compressor 152 to the pressurized fluidized bed combustor pressure vessel 172 via line 182, e.g., at a pressure of about 16 atmospheres.

The air handler system 20 shown in FIG. 4 is used to feed pressurized air from the wind funnel 10 to the various components in the multiple stage gas turbine system 140. Ambient air 108 may enter the low pressure compressor 167, and then be delivered by line 169 to the mid-pressure compressor 165, e.g., at a pressure of about 1.4 atmospheres The air pressure may be increased in the mid-pressure compressor, e.g., to a pressure of about 4.5 to 5 atmospheres, and then fed by a mid-pressure air supply line to the high-pressure compressor 152. Air pressure may be raised in the high-pressure compressor, e.g., to about 16 atmospheres, and delivered by-line 182 to the pressurized fluidized bed combustor pressure vessel 172.

Compressed air from the wind funnel 10 is delivered from the air handler system 20 to the beginning of the mid-pressure compressor 165 via line 141, and the actuator 168 can disconnect the low pressure compressor 168 using the second coupler 166, torque fuel coal costs may thereby be lowered. Alternatively, if there is more compressed air pressure available, the air handler system 20 can direct the higher pressure air from the wind funnel 10 via line 142 to an appropriate mid row circle of blades of the mid-pressure compressor 165, and the second generator 160 can be run at higher rpm for more watts. The selective delivery via lines 141 and 142 to different rows of rotatable turbine blades in the mid-pressure compressor may be achieved in accordance with the teachings of U.S. patent application Ser. No. 16/386,451. Alternatively, if there is a very high quantity of compressed air from the wind funnel 10, and very low demand, both the low-pressure compressor 167 and mid-pressure compressor 165 can be disconnected and the second generator 160 can be disconnected using the actuator 161 and coupler 162. In this configuration, all compressed air from the wind funnel 10 can be directed via line 143 to the high pressure compressor 152. The selective coupling of the generator sections may be achieved in accordance with the teachings of U.S. patent application Ser. No. 16/386,451.

In certain embodiments, the coal-fired boiler 30 may be used to generate any suitable power output. For example, power outputs of from 3 to 2,300 MW, or from 5 to 2,000 MW, may be provided. The efficiency of coal-fired power plants can be increased significantly due to the supply of compressed air from the air funnel 10. As used herein, the term “increased efficiency” when referring to the operation of a coal-fired power plant means the percentage decrease in the amount of coal that is consumed during operation of the power plant for a given power output level due to the supply of compressed air from the air funnel 10. For coal-fired power plants, the amount of coal consumed during operation may be described in units of kg/MW hour, or kg/hour for a given power output, e.g., 1 Mega Watt.

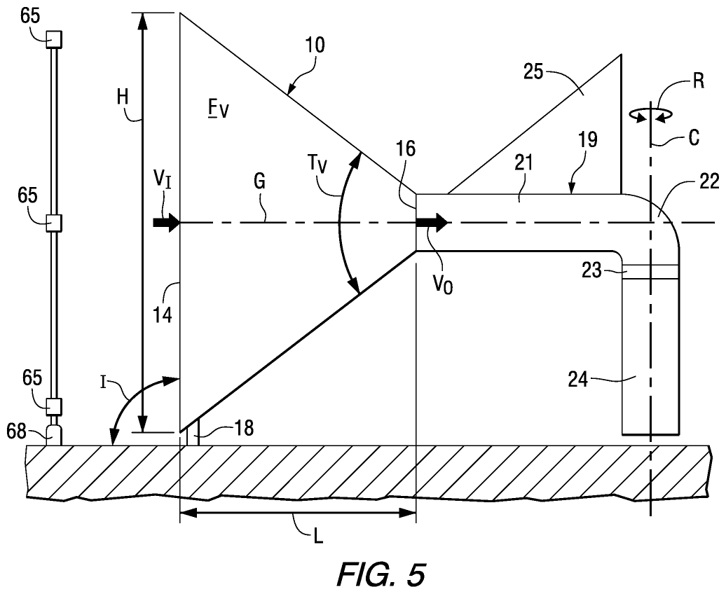

As shown in FIG. 5. the wind funnel 10 may be provided with at least one air sensor 65 for receiving sensed parameters such as wind speed, wind direction, temperature, barometric pressure and the like. As schematically shown in FIGS. 1-4, the system may include an air control system 70 into which signals from the air sensors 65 are fed. An adjustment actuator 80 may be used to control the orientation of the wind funnel 10. The air control system 70 may send input signals to the adjustment actuator 80, which may be used to change the orientation of the wind funnel 10, as more fully described below. A power plant control system 90 communicates with the coal-fired boiler 30 and the air control system 70 to coordinate operation of the boiler 30 including selective air delivery through the air handler system 20 from the wind funnel 10 and/or pressurized ambient air A from air compressor 100.

The wind funnel 10, air control switch 20, air sensor module 65, air control system 70, adjustment actuator 80 and power plant control system 90 may operate together as follows: the air sensor module 65 may detect air speed, temperature and/or density of air currents near the opening of the wind funnel 10 and/or inside the wind funnel 10. Signals from the air sensors 65 may be sent to the air control system 70, which communicates with the power plant control system 90. The power plant control system 90, makes decisions as to the composition of the air desired, and coveys those orders back to the air control system 70. The air control system 70 may make mechanical decisions as to air flow, and may use the adjustment actuator 80 to control which direction the wind funnel 10 faces for optimum air intake. The air control system 70 may also have the ability to manipulate the air control switch 20, to control the flow of pressurized air into the combustion zone 32 of the boiler 30 via the wind funnel 10, ambient air A and/or steam turbine air compressor 100.

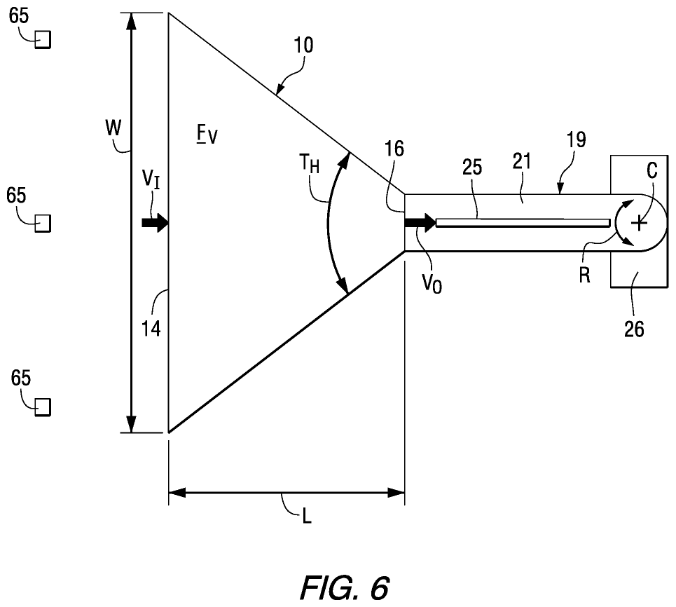

FIG. 5 is a partially schematic side view and FIG. 6 is a partially schematic top view of a wind funnel 10 that may be used with coal-fired power plant turbine systems 5, 120 and 140 as described above. The wind funnel 10 has a tapered body 12, inlet opening 14, and outlet opening 16. As shown in FIG. 5, a support member 18 may be used to support the wind funnel 10 on the ground or floor. The support member 18 may be of any suitable design, such as a wheel or roller that may roll on the ground or on a track to provide up to 360° rotation of the wind funnel in a substantially horizontal plane.

The array of air sensors 65 is positioned adjacent to the wind funnel 10, and may be supported by any suitable structure, such as the base support member 68 shown in FIG. 5 or any other suitable structure, e.g., a metal cable (not shown) extending across the inlet opening 14 or mouth of the wind funnel 10. Data from the wind sensors 65 may be transmitted by wire or wirelessly to the air control system 70. Each wind funnel 10 may have its own air sensors 65, e.g., mounted on metal cables. A farm of wind funnels may be provided, having their own area of wind, temperature and humidity sensors, e.g., on poles in four comers of a wind farm transmitting data back to the air sensors 65.

The wind funnel and coal-fired power plant systems 5, 120 and 140 may also include a transfer pipe 19. A rotation joint 23 may be used to connect the transfer pipe 19 to the air inlet 11 of the boiler 30. The wind funnel 10 may be rotatable 360° in a substantially horizontal plane through the use of the rotation joint 23 and support member 18. The transfer pipe 19 may have any suitable cross-sectional shape, such as circular, square, rectangular or the like.

The air inlet 11 of the boiler 30 may also have any suitable cross-sectional shape and dimensions, as more fully described below. A single air inlet 11 or multiple additional air inlets 11A and 11B may be used. For example, two, three or four air inlets may be provided at desired locations around the circumference of the coal-fired boiler 30, in which case an air manifold of any suitable design may be used to deliver pressurized air from the wind funnel 10 and transfer pipe 19 to the multiple air inlets of the boiler 30.

As schematically shown in FIGS. 5 and 6, a directional vane 25 may be mounted on the body of the transfer pipe 19 to facilitate alignment of the wind funnel 10 with the prevailing wind direction. The directional vane 25 may be of any suitable construction, such as a plastic or metal sheet, or a flexible fabric fastened to an angled metal pole at the leading edge of the vane 25.

As shown in the side view of FIG. 5, the wind funnel 10 is inwardly tapered between the inlet opening 14 and the outlet opening 16 at a vertical taper angle T_{V}, which is measured in a vertical plane. As further shown in FIG. 5, the inlet opening 14 of the wind funnel 10 is oriented at an inclination angle I measured from a horizontal plane. As further shown in Fig. 5, the inlet opening 14 of the wind funnel 10 has a height H. A horizontal or ground plane G is labeled in FIG. 5.

As shown in the top view of FIG. 6, the wind funnel 10 has a horizontal taper angle T_{H} between the inlet opening 14 and outlet opening 16, which is measured in a horizontal plane. As further shown in FIG. 5, the inlet opening 14 of the wind funnel 10 has a width W. As shown in FIGS. 5 and 6, the wind funnel 10 has a length L measured between the inlet opening 14 and outlet opening 16.

In accordance with embodiments of the present invention, the vertical taper angle T_{V} shown in FIG. 5 may typically range from 20 to 120°, for example, from 30 to 90°, or from 35 to 70°, or from 45 to 65°.

In accordance with embodiments of the present invention, the horizontal taper angle T_{H} shown in FIG. 6 may typically range from 30 to 90°, for example, from 45 to 85°, or from 60 to 75°.

In certain embodiments, the ratio of the vertical taper angle to horizontal taper angle T_{V}:T_{H} may typically range from 1.4 to 3:1, for example, from 1:3 to 2:1, or from 1:2 to 1.1.

In accordance with embodiments of the present invention, the inclination angle I shown in FIG. 5 may typically range from 75 to 120°, for example, from 80 to 100°, or from 85 to 95°. In certain embodiments, the inclination angle I is 90°. However, any other suitable inclination angle may be used.

In accordance with certain embodiments, the height H of the wind funnel inlet opening 14 shown in FIG. 5 may typically range from 5 to 300 meters, for example, from 10 to 150 meters, or from 20 to 120 meters. However, any other suitable height H may be used, e.g., based on land availability, topography and the like.

In accordance with certain embodiments, the width W of the wind funnel inlet opening 14 shown in FIG. 6 may typically range from 5 to 300 meters, for example, from 10 to 150 meters, or from 20 to 120 meters. However, any other suitable width W may be used.

In accordance with certain embodiments, the length L of the wind funnel inlet opening 14 as shown in FIGS. 5 and 6 may typically range from 5 to 300 meters, for example, from 10 to 150 meters, or from 20 to 120 meters.

In certain embodiments, the ratio of the height to length H:L may typically range from 1:3 to 3:1, for example, from 1:2 to 2:1, or from 1:1.5 to 1.5:1.

In certain embodiments, the ratio of the width to length W:L may range from 1:3to 3:1, for example, from 1:2 to 2:1, or from 1:1.5 to 1.5:1.

In certain embodiments, the height H and the width W may be the same. Alternatively, the height H and width W may be different. For example, the height to width ratio H:W may range from 1:3 to 3:1, for example, from 1:2 to 2:1, or from 1:1.5 to 1.5:1.

In accordance with the present invention, the inlet opening has a cross-sectional area A_{I} larger than a cross-sectional area A_{O} of the outlet opening. In certain embodiments, the cross-sectional area ratio A_{I}:A_{O} may typically range from 3:1 to 80,000:1, for example, from 5:1 to 10,000:1, or from 10:1 to 5,000:1, or from 20:1 to 1,000:1.

The wind funnel 10 has an internal volume F_{V} that may typically range from 1,000 to 15,000,000 m³ , for example, from 10,000 to 12,000,000 m³, or from 100,000 to 5,000,000 m³. In certain embodiments, the internal volume F_{V} of the wind funnel 10 may be selected depending upon the power output of the natural gas turbine 30 in MW, e.g., the ratio of F_{V}:MW may typically range from 10,000:1 to 200,000:1, for example, from 50,000:1 to 100,000; 1, or from 55,000:1 to 85,000:1. While the use of a single wind funnel 10 is primarily described herein, it is to be understood that two or more wind funnels may be used in combination to feed a single gas turbine.

Factors to consider when selecting the size and configuration of the wind funnel(s) 10 include: availability of land around the coal-fired power plant to allow the wind funnel 10 to circle around one turbine or to circle around a specific point to capture the compressed wind and then transport it to the turbine by pipe: topography and relative location of the power plant to concentrating wind funnels that surround it; height above sea level to determine air density for time period when it is used; time of day wind speed average; ambient temperature of the time period when the wind power will occur; and/or specific turbine size.

As further shown in FIGS. 5 and 6, ambient wind may enter the inlet opening 14 of the wind funnel 10 at an air velocity V_{I}, and exit through the outlet opening at an air velocity Vo. In certain embodiments, the outlet to inlet air velocity ratio V_{O}:V_{I} may range from 1.5:1 to 100:1, for example, from 2:1 to 50:1, or from 5:1 to 20:1.

The air pressure at the outlet P_{O} of the wind funnel 10 is greater than the ambient air pressure P_{I} at the inlet of the wind funnel, e.g., the ratio of P_{O}:P_{I} may typically range from 1.1:1 to 10:1, for example, from 1.2:1 to 5:1, or from 1.5:1 to 3:1.

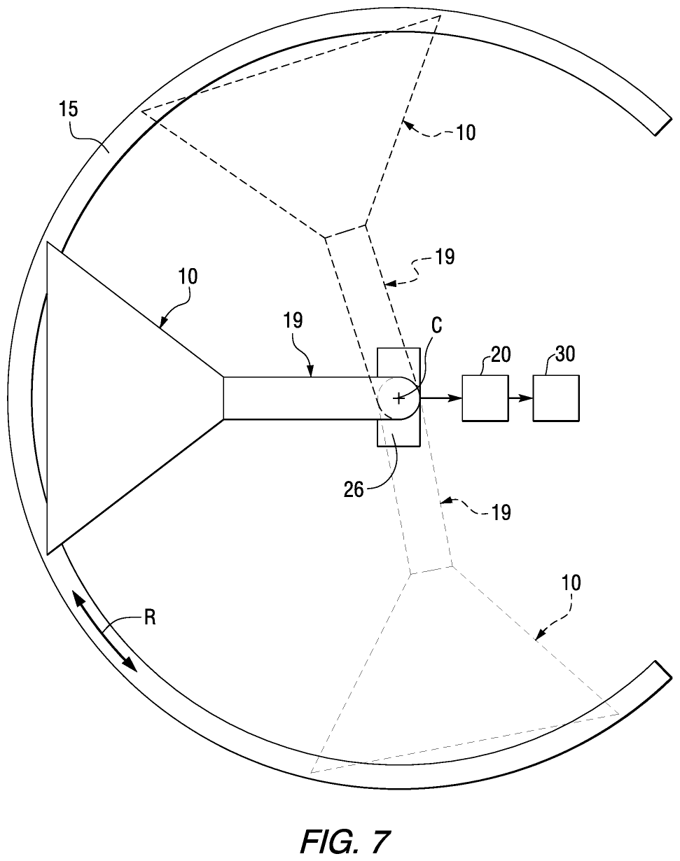

As shown in FIG. 7, the transfer pipe 19, and the attached wind funnel 10, may rotate R around the central rotational axis C in order to adjust the orientation of the wind funnel 10. For example, if the direction of the prevailing wind changes, the wind funnel 10 may be pivoted into a position in which the prevailing wind meets the inlet opening 14 head on in order to maximize the inlet opening air velocity V_{I} during operation. The directional vane 25 may be used to align the wind funnel 10 with the prevailing wind direction. While the coal-fired power plant 30 remains in a stationary position, the wind funnel 10 may be selectively rotated in an arc of up to 360° in order to maximize the inlet opening air velocity V_{I}. Although a full rotational movement R of 360° is within the scope of the present invention, the arc transversed by the rotational movement may be less than 360° in certain embodiments, for example, 270° or 180°.

In the embodiment shown in FIG. 7, the wind funnel 10 and its support members 18 may be supported and guided along a circular track 15, which in the embodiment shown extends in a 270° arc around the central rotational axis C. For example, the track 15 may comprise two railroad tracks that each support two metal or polymeric roller wheels for a total of four wheels for each support member 18.

Although in the embodiment shown in the figures, the wind funnel 10 and transfer pipe 19 are shown as being fixed together, it is to be understood that an articulated joint (not shown) between the wind funnel 10 and transfer pipe 19 may be used in addition to, or in place of, the central rotational axis C and rotation joint 24 illustrated in the figures. In addition, any other suitable mounting mechanism or configuration may lie used in accordance with the present invention that allows control of the wind funnel orientation while maintaining air flow communication between the wind funnel and the combustion zone 32 of the coal-fired boiler 30.

In accordance with embodiments of the present invention, the configuration of the transfer pipe 19 may be controlled based upon the particular configuration of the upstream wind funnel 10. For example, the cross-sectional shape and size of the transfer pipe 19 may be controlled, the overall length of the transfer pipe may be controlled, and the shape and dimensions of all the longitudinal length of the transfer pipe 19 may be controlled. In certain embodiments, the inlet of the transfer pipe 19 substantially matches the outlet opening 16 of the wind funnel 10. Thus, the cross-sectional shapes and dimensions may be matched. However, in other embodiments, the inlet of the transfer pipe 19 may not match the outlet opening 16 of the wind funnel 10.

In the embodiment shown in the figures, the transfer pipe 19 may have an inner diameter defining a cross-sectional area similar to the cross-sectional area A_{O} of the outlet opening. In certain embodiments, the cross-sectional area of the transfer pipe 19 is maintained substantially constant along the longitudinal length of the transfer pipe 19. However, in other embodiments, the cross-sectional area of the transfer pipe 19 may vary along its length, e.g., the transfer pipe 19 may taper inwardly slightly from its inlet to its outlet.

The transfer pipe 19 may be provided in any suitable length. For example, the overall length of the transfer pipe 19 may be minimized in order to reduce air friction, pressure drops or deceleration of the air as it passes through the transfer pipe 19.

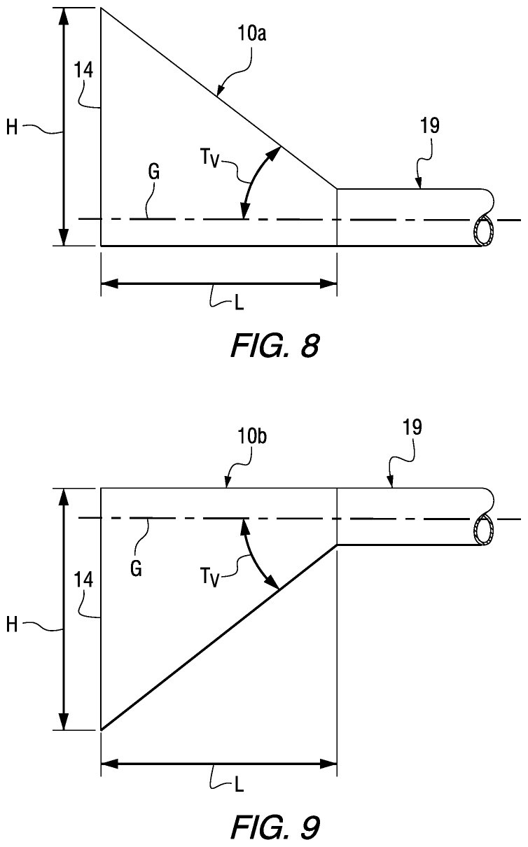

In certain embodiments, the length of the transfer pipe 19 and shape of the wind funnel 10 are controlled in order to provide sufficient clearance space for the transfer pipe 19 and wind funnel 10 to rotate in relation to the boiler 30 without being obstructed. Alternative wind funnel and or transfer pipe configurations may be provided to ensure sufficient clearance during rotation, for example, a flat-bottom wind funnel 10a such as shown in the embodiment of FIG. 8 may be used to provide additional clearance as the wind funnel rotates above the turbine housing 35.

The air inlet 11 may have an inner diameter defining a cross-sectional area that may be the same as, or smaller titan, the inner diameter and cross-sectional area of the transfer pipe 19. In certain embodiments, the cross-sectional area of the air inlet 11 is maintained substantially constant along the longitudinal length of the air inlet 11. However, in other embodiments, the cross-sectional area of the air inlet 11 may vary along its length, e.g., the air inlet 11 may taper inwardly slightly from its inlet to its outlet.

The air inlet 11 may be provided in any suitable length. For example, the overall length of the air inlet 11 may be minimized in order to reduce air friction, pressure drops or deceleration of the air as it passes through the air inlet 11.

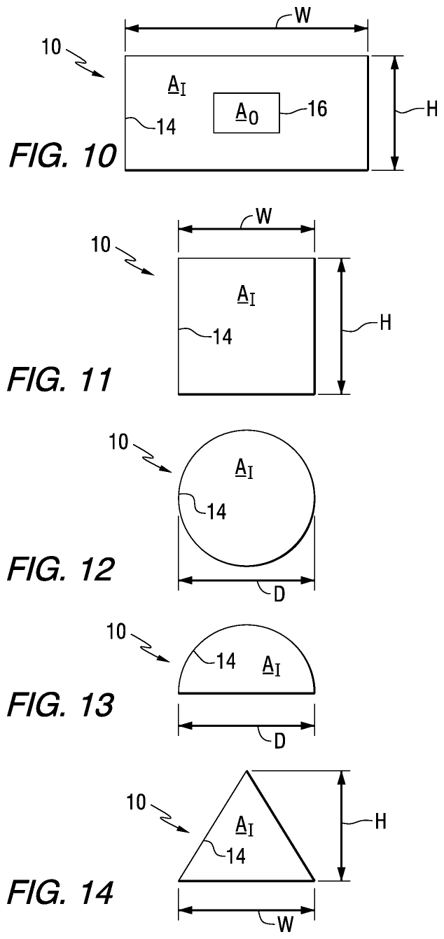

FIGS. 8 and 9 are side views of alternative wind funnel configurations in accordance with embodiments of the invention, in FIG. 8, the wind funnel 10a has a lower surface that is substantially parallel with the horizontal plane G. The vertical taper angle T_{V} thus extends from the substantially horizontal bottom surface to the angled upper surface of the wind funnel 10a. In FIG. 10, the wind funnel 10b has an upper surface that is substantially parallel with the horizontal plane G and an angled lower surface. In thus embodiment, the vertical taper angle T_{V} is measured from the upper substantially horizontal surface to the lower angled surface. In each of the embodiments shown in FIGS. 8 and 9, the vertical taper angle T_{V} may fall within the vertical taper angle T_{V} ranges described above in connection with the embodiment shown in FIG. 2.

FIGS. 10-14 are partially schematic end views of wind funnels 10 having various types of cross-sectional shapes in accordance with embodiments of the invention.

In the embodiment shown in FIG. 10, the inlet opening 14 of the wind funnel 10 has a rectangular shape, and the outlet opening 16 also has a rectangular shape. The inlet opening 14 has a cross-sectional area A_{I} corresponding to the product of W·H. The outlet opening 16 has a smaller cross-sectional area A_{O} which, in the embodiment shown, represents the product of the height and width of the outlet opening multiplied together. As described above, the ratio of A_{I}:A_{O} may typically range from 3:1 to 80,000:1, for example, from 5:1 to 10,000:1, or from 10:1 to 5,000:1, or from 20:1 to 1,000:1.

In the embodiment shown in FIG. 11. the inlet opening 14 of the wind funnel 10 has a generally square cross-sectional shape with a cross-sectional area At corresponding to the product of W·H. Although not shown in FIG. 11, the wind funnel 10 also has an outlet opening 16 of any desired cross-sectional shape, such as square, rectangular, round or the like.

In the embodiment shown in FIG. 12, the inlet opening 14 of the wind funnel 10 is generally circular with a diameter D. The cross-sectional area A_{I} is also labeled in FIG. 12.

In the embodiment shown in FIG. 13, the inlet opening 14 of the wind funnel 10 is generally hemispherical and has a diameter D. The cross-sectional area A_{I} of the inlet opening is also labeled in FIG. 13.

In the embodiment shown in FIG. 14, the inlet opening 14 of the wind funnel 10 is has a generally triangular shape with a height H and width W. The cross-sectional area A_{I} is also labeled in FIG. 14.

Although various wind funnel cross-sectional shapes are illustrated in FIGS. 10-14, it is to be understood that any other suitable cross-sectional shape of the inlet opening 14 and or outlet opening 16 may be used in accordance with the present invention.

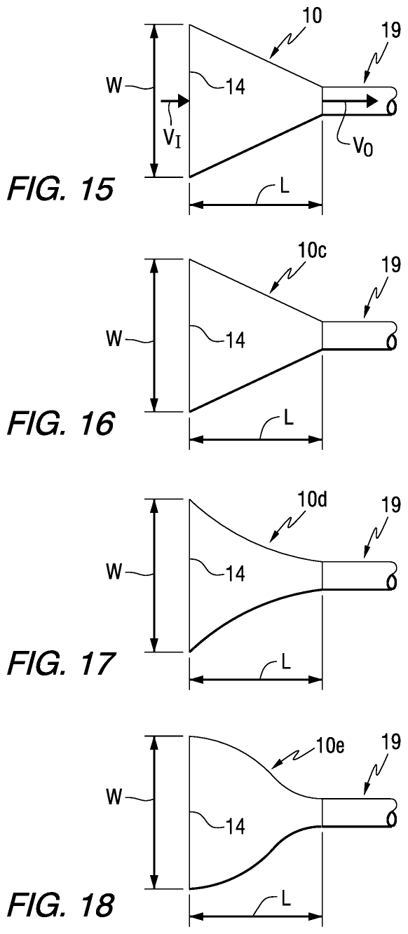

FIGS. 15-18 are top views schematically illustrating various wind funnel configurations in accordance with embodiments of the present invention.

In the embodiment shown in FIGS. 15 and 16, the body of the wind funnel 10 includes generally fiat angled sides similar to the embodiments shown in FIGS. 5 and 7; however, the sides may alternatively be convex.

In the embodiment shown in FIG. 17, the wind funnel 10d comprises a concavely curved outer surface.

In the embodiment shown in FIG. 18, the wind funnel 10e comprises a complex curved outer surface including a convex portion near the inlet opening 14 and a concave portion near the exit opening.

In the embodiments shown in FIGS. 15-18, the various wind funnels have a width W and a length L, which may correspond to the widths W and lengths L described above.

In accordance with embodiments of the present invention, the particular configuration of the wind funnel 10 may be selected based upon various parameters or factors such as prevailing wind speeds, land topography, land availability, elevation, ambient temperature, turbine output power and the like. For example, computer modeling may be performed in order to optimize the shape and size of the wind funnel 10.

Whereas particular embodiments of this invention have been described above for purposes of illustration, it will be evident to those skilled in the art that numerous variations of the details of the present invention may be made without departing from the invention as defined in the appended claims.

What is claimed is:

1. A wind funnel and coal-fired power plant system comprising.
a wind funnel comprising an inlet opening having a cross-sectional area and an outlet opening having a cross-sectional area less than the cross-sectional area of the inlet opening, wherein the wind funnel is inwardly tapered between the inlet opening and the outlet opening;
an air handler system in air flow communication with the wind funnel; and
a coal-fired electrical power generation system in air flow communication with the air handler system structured and arranged to receive at least a portion of compressed air delivered from the wind funnel through the air handler system.

2. The wind funnel and coal-fired power plant system of claim 1, wherein the coal-fired electrical power generation system comprises a coal-fired boiler.

3. The wind funnel and coal-fired power plant system of claim 2, wherein the compressed air from the wind funnel is delivered to a combustion zone of the coal-fired boiler.

4. The wind funnel and coal-fired power plant system of claim 3, wherein the compressed air from the wind funnel is delivered to the combustion zone at a pressure above atmospheric pressure.

5. The wind funnel and coal-fired power plant system of claim 2, wherein the coal-fired boiler comprises a fluidized bed.

6. The wind funnel and coal-fired power plant system of claim 5, wherein the compressed air from the wind funnel is delivered to the fluidized bed at multiple locations.

7. The wind funnel and coal-fired power plant system of claim 6, wherein the air from the wind funnel is delivered.
to a combustion zone above the fluidized bed;
into the fluidized bed; or
below the fluidized bed.

8. The wind funnel and coal-fired power plant system of claim 5, wherein the fluidized bed is pressurized.

9. The wind funnel and coal-fired power plant system of claim 2, wherein the air handler system receives hot flue gas from the coal-fired boiler and is structured and arranged to pre-heat the compressed air from the wind funnel with the hot flue gas prior to delivery of the compressed air to the coal-fired boiler.

10. The wind funnel and coal-fired power plant system of claim 2, wherein the coal-fired boiler feeds high pressure steam to a steam turbine, low pressure steam is fed from the steam turbine to the air handler system, and the air handler system is structured and arranged to pre-heat the compressed air from the wind funnel with the low pressure steam prior to delivery of the compressed air to the coal-fired boiler.

11. The wind funnel and coal-fired power plant system of claim 1, wherein the coal-fired electrical power generation system comprises:
a first gas combustion generator section;
a second gas combustion generator section; and
a steam generator section comprising a pressurized fluidized bed combustor, wherein at least a portion of the compressed air delivered from the wind funnel through the air handler system is selectively delivered to a mid-pressure compressor of the second gas combustion generator section and to a high-pressure compressor of the first gas combustion generator section.

12. The wind funnel and coal-fired power plant system of claim 11, wherein the mid-pressure compressor comprises multiple rows of rotatable turbine blades, and the compressed air delivered from the wind funnel through the air handler system is selectively delivered to different rows of the rotatable turbine blades.

13. The wind funnel and coal-fired power plant system of claim 11, wherein the second gas combustion generator section comprises a low-pressure compressor structured and arranged to be releasably coupled to the mid-pressure compressor of the second gas combustion generator section.

14. The wind funnel and coal-fired power plant system of claim 11, wherein the pressurized fluidized bed combustor comprises a pressure vessel surrounding a coal-fired boiler having a heat exchanger contained therein.

15. The wind funnel and coal-fired power plant system of claim 14, further comprising a high pressure air line structured and arranged to deliver high pressure air front the high-pressure compressor of the first gas combustion generator section to the pressure vessel of the pressurized fluidized bed combustor.

16. The wind funnel and coal-fired power plant system of claim 1, wherein the air handler system comprises at least one of a heat exchanger and a pre-heater, and air from the wind funnel is delivered to at least one of the heat exchanger and the pre-heater

17. The wind funnel and coal-fired power plant system of claim 16, further comprising an air fan structured and arranged to deliver ambient air to a coal-fired boiler of the coal-fired electrical power generation system.

18. The wind funnel and coal-fired power plant system of claim 17, wherein the fan is structured and arranged to selectively deliver the ambient air to at least one of the heat exchanger and the pre-heater.

19. The wind funnel and coal-fired power plant system of claim 1, wherein the wind funnel is rotatable around a vertical axis to adjust for different prevailing wind directions, the inlet opening of the wind funnel has a cross-sectional area A_{I}, the outlet opening of the wind funnel has a cross-sectional area A_{O}, a cross-sectional area ratio A_{I}:A_{O} is from 5:1 to 10,000:1, and the wind funnel has an internal volume F_{V} of 1,000 to 15,000,000 m³.

20. A method of operating a wind funnel and coal-fired power plant system comprising:
feeding compressed air from a wind funnel to an air handler system; and
delivering at least a portion of the compressed air from the wind funnel through the air handler system to a coal-fired electrical power generation system.

21. The method of claim 20, wherein the coal-fired electrical power generation system comprises a coal-fired boiler, and the at least a portion of the compressed air from the wind funnel is fed through the air-handier system into a combustion zone of the coal-fired boiler.

22. The method of claim 21, wherein the coal-fired boiler comprises a fluidized bed, and the compressed air from the wind funnel is delivered into the coal-fired boiler in at least one location above the fluidized bed, in the fluidized bed, or below the fluidized bed.

23. The method of claim 22, wherein the coal-fired electrical power generation system comprises:
a first gas combustion generator section;
a second gas combustion generator section; and
a steam generator section comprising a pressurized fluidized bed combustor, wherein at least a portion of the compressed air delivered from the wind funnel through the air handler system is selectively delivered to a mid-pressure compressor of the second gas combustion generator section and to a high-pressure compressor of the first gas combustion generator section. 24. The method of claim 20, wherein the wind funnel comprises an inlet opening having a cross-sectional area and an outlet opening having a cross-sectional area less than the cross-sectional area of the inlet opening, the wind funnel is inwardly tapered between the inlet opening and the outlet opening, and the wind funnel is rotatable around a vertical axis to adjust for different prevailing wind directions. 25. The method of claim 20, wherein the inlet opening of the wind funnel has a cross-sectional area A_{I}, the outlet opening of the wind funnel has a cross-sectional area A_{O}, and a cross-sectional area ratio A_{I}:A_{O} is front 5:1 to 10,000:1, and wherein the wind funnel has an internal volume F_{V} of 1,000 to 15,000,000 m³.
